(19) United States
(12) Patent Application Publication
(10) Pub. No.: US 2008/0082908 A1
(43) Pub. Date: Apr. 3, 2008

(54) APPARATUS AND METHOD FOR DATA CHARTING WITH ADAPTIVE LEARNING

(75) Inventor: John Malcolm MacGregor, Ascot (GB)

Correspondence Address: COOLEY GODWARD KRONISH LLP;ATTN: Patent Group, Suite 1100, 777 - 6th Street, NW, Washington, DC, 20001, US

(73) Assignee: Business Objects, S.A., Levallois-Perret (FR)

(21) Appl. No.: 11/537,586

(22) Filed: Sep. 29, 2006

(51) Int. Cl. G06F 17/00

(52) U.S. Cl. 715/215; 715/212; 715/227

(57) ABSTRACT

A computer implemented method of processing data includes creating a data table characterizing data values, receiving a data selection from within the data table, and automatically generating a data chart based on the data selection. A specified preference may be recorded. The specified preference may be applied to create a revised data chart.

### BRIEF DESCRIPTION OF THE INVENTION

The present invention relates generally to data processing. More particularly, the present invention relates to a technique for efficiently charting groups of data values.

### BACKGROUND OF THE INVENTION

Business Intelligence (BI) generally refers to software tools used to improve business enterprise decision-making. These tools are commonly applied to financial, human resource, marketing, sales, customer and supplier analyses. More specifically, these tools can include: reporting and analysis tools to present information; content delivery infrastructure systems for delivery and management of reports and analytics; data warehousing systems for cleansing and consolidating information from disparate sources; and data management systems, such as relational databases or On Line Analytic Processing (OLAP) systems used to collect, store, and manage raw data.

There are a number of commercially available products to produce reports from stored data. For instance, Business Objects Americas of San Jose, Calif., sells a number of widely used report generation products, including Crystal Reports™, Business Objects OLAP Intelligence™, Business Objects Web Intelligence™, and Business Objects Enterprise™. As used herein, the term report refers to information automatically retrieved (i.e., in response to computer executable instructions) from a data source (e.g., a database, a data warehouse, a plurality of reports, and the like), where the information is structured in accordance with a report schema that specifies the form in which the information should be presented. A non-report is an electronic document that is constructed without the automatic retrieval of information from a data source. Examples of non-report electronic documents include typical business application documents, such as a word processor document, a presentation document, and the like.

A report document specifies how to access data and format it. A report document where the content does not include external data, either saved within the report or accessed live, is a template document for a report rather than a report document. Unlike other non-report documents that may optionally import external data within a document, a report document by design is primarily a medium for accessing and formatting, transforming or presenting external data.

A report is specifically designed to facilitate working with external data sources. In addition to information regarding external data source connection drivers, the report may specify advanced filtering of data, information for combining data from different external data sources, information for updating join structures and relationships in report data, and logic to support a more complex internal data model (that may include additional constraints, relationships, and metadata).

In contrast to a spreadsheet, a report is generally not limited to a table structure but can support a range of structures, such as sections, cross-tables, synchronized tables, sub-reports, hybrid charts, and the like. A report is designed primarily to support imported external data, whereas a spreadsheet equally facilitates manually entered data and imported data. In both cases, a spreadsheet applies a spatial logic that is based on the table cell layout within the spreadsheet in order to interpret data and perform calculations on the data. In contrast, a report is not limited to logic that is based on the display of the data, but rather can interpret the data and perform calculations based on the original (or a redefined) data structure and meaning of the imported data. The report may also interpret the data and perform calculations based on pre-existing relationships between elements of imported data. Spreadsheets generally work within a looping calculation model, whereas a report may support a range of calculation models. Although there may be an overlap in the function of a spreadsheet document and a report document, these documents express different assumptions concerning the existence of an external data source and different logical approaches to interpreting and manipulating imported data.

The present invention relates to the analytical and reporting aspects of BI. A business record or business data value is a measure of the performance of an enterprise (e.g., commercial, governmental, non-profit, etc.). The business data value may be financial, human resource, marketing, sales, customer or supplier information. While there are existing tools to chart business data values graphically, these tools do not allow for immediate graphical representation of business records and are not adaptive to user specific preferences.

Therefore, it would be desirable to provide a new technique that reflects user preferences and that enables immediate graphical representation of business records. In particular, it would be desirable to provide a method that provides immediate graphical representation of business data values while concurrently being adaptive to user specific preferences.

### SUMMARY OF THE INVENTION

The invention includes a computer-readable storage medium to direct a computer to function in a specified manner. The computer-readable storage medium includes executable instructions to create a data table characterizing data values. A data selection from within the data table is received. A data chart based on the data selection is automatically generated. A specified preference may be recorded. The specified preference may be applied to create a revised data chart.

The invention also includes a computer implemented method of processing data. A data table characterizing data values is created. A data selection from within the data table is received A data chart is automatically generated based on the data selection. A specified preference may be recorded. The specified preference may be applied to create a revised data chart.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a computer that may be operated in accordance with an embodiment of the invention.

FIG. 2 illustrates processing operations performed in accordance with an embodiment of the invention

FIG. 3 illustrates an exemplary data table that may be presented in accordance with an embodiment of the invention.

FIG. 4 illustrates the data table of FIG. 3 with a chart selection menu utilized in accordance with an embodiment of the invention.

FIG. 5 illustrates a vertical bar chart formed in accordance with an embodiment of the invention.

FIG. 6 illustrates a pie chart formed in accordance with an embodiment of the invention.

FIG. 7 illustrates a horizontal bar chart formed in accordance with an embodiment of the invention.

### DETAILED DESCRIPTION OF THE INVENTION

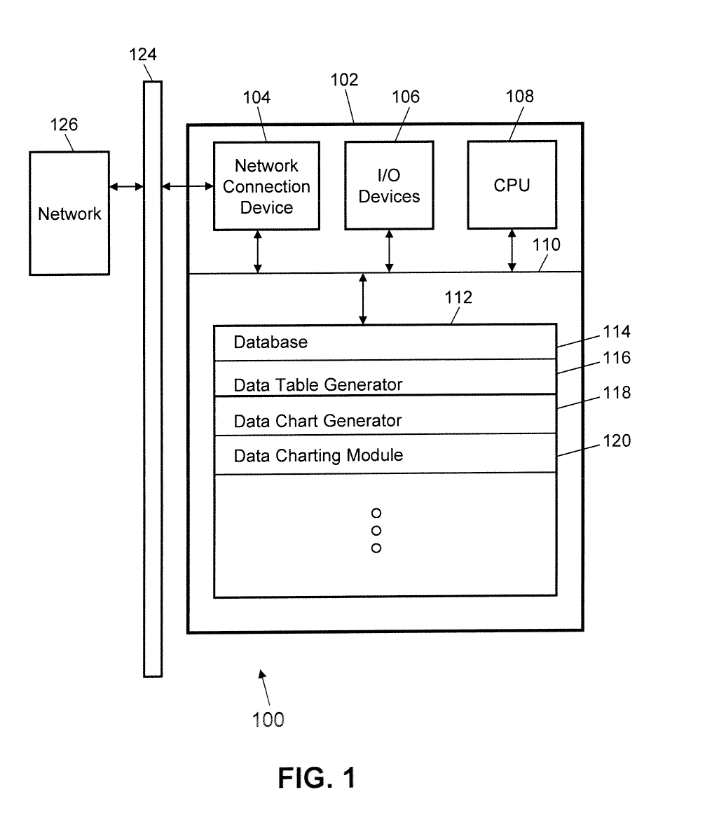

FIG. 1 illustrates a computer network 100 that may be operated in accordance with an embodiment of the invention. The computer network 100 includes a computer 102, which, in general, may be a client computer or a server computer. In the present embodiment of the invention, the computer 102 is a server computer including conventional server computer components. As shown in FIG. 1, the computer 102 includes a Central Processing Unit (“CPU”) 108 that is connected to a network connection device 104 and a set of input/output devices 106 (e.g., a keyboard, a mouse, a display, a printer, a speaker, and so forth) via a bus 110. The network connection device 104 is connected to network 126 through a network transport medium 124, which may be any wired or wireless transport medium.

The CPU 108 is also connected to a memory 112 via the bus 110. The memory 112 stores a set of executable programs to implement operations of the invention. One executable program is the data table generator 116. The data table generator 116 includes executable instructions to access a data source to produce a data table (e.g., comprising various business records). By way of example, the data source may be database 114 resident in memory 112. The data source may be located anywhere in the network 126. A data table is an instrument that may be used by an enterprise to present a matrix of data values.

As shown in FIG. 1, the memory 112 also contains a data chart generator 118. The data chart generator 118 includes executable instructions to access a data source containing business data values and produce a data chart. A data chart is a graphical representation of data such as a vertical bar chart, a horizontal bar charts a pie chart, a line chart or a scatter plot (sometimes called a scatter graph or a scatter diagram).

In one embodiment of the invention, the data chart generator 118 immediately charts data values chosen by the user that are associated with the data table generated by the data table generator 116. Thus, the data chart generator 118 automatically implements a data chart based upon the selected values within a data table. The automatically generated chart is based upon a default value or adaptively learned information about a user's preferences. Initially, a default value is typically used. Thereafter, adaptively learned preferences are automatically applied.

FIG. 1 also shows that the memory 112 contains a data charting module 120. The data charting module 120 provides a graphical user interface to allow a user to specify chart preferences. The data charting module 120 includes executable instructions to adaptively learn a user's preferences. This preference information is then passed to the data chart generator 118, which uses the preference information to automatically generate data charts based upon subsequent user selections of data table values.

While the various components of memory 112 are shown residing in the single computer 102, it should be recognized that such a configuration is not required in all applications. For instance, the data charting module 120 may reside in a separate computer (not shown in FIG. 1) that is connected to the network 126. Similarly, separate modules of executable code are not required. The invention is directed toward the operations disclosed herein. There are any number of ways and locations to implement those operations, all of which should be considered within the scope of the invention.

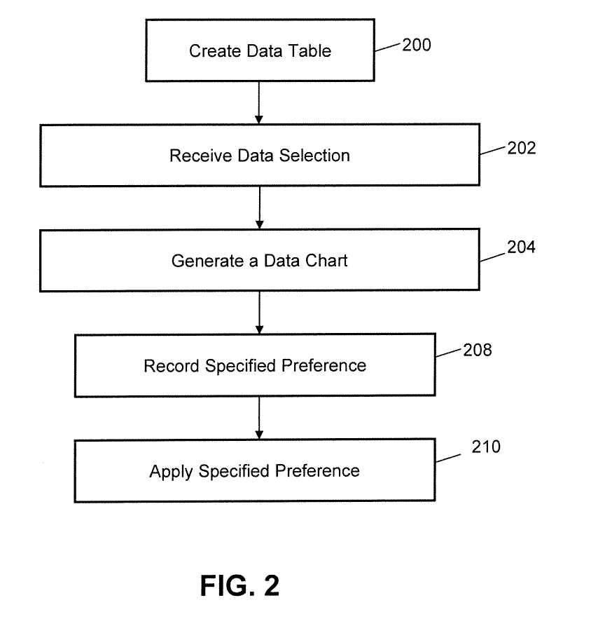

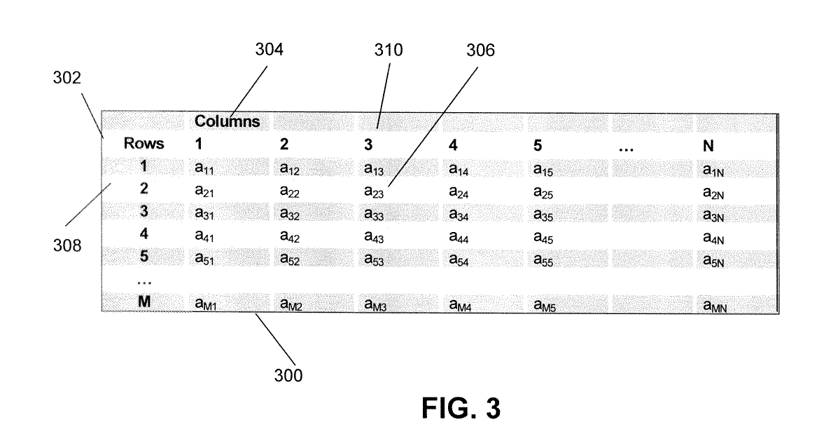

FIG. 2 illustrates processing operations associated with an embodiment of the invention. The first processing operation shown in FIG. 2 is to create a data table 200. In one embodiment of the invention, this is implemented with executable code of the data table generator 116. An example of the format of a data table that may be generated is shown in FIG. 3.

FIG. 3 illustrates a data table 300 that presents various sample business records for different Rows 302, 1 to M, and Columns 304, 1 to N. The business data values may represent various business records or other information associated with a business. Each business record in the data table may be specified by a given row and column. For instance, business record 306 may be specified by Row 2 308 and Column 3 310. Accordingly, the data table 300 presents the format of a sample data table consisting of various business records characterized by a series of Rows 302, 1 to M, and Columns 304, 1 to N.

Returning to FIG. 2, the next processing operation is to receive a data selection 202. In one embodiment of the invention, this is implemented with executable code from the data charting module 120. The data charting module 120 may receive a data selection from the user, signaling what business data values the user desires to have charted. Data selection enables the user to directly choose from a data table which business records are to be charted. The user may select any column, portion of a column (column vector), row, portion of a row (row vector) or combinations thereof.

The data selection made by the user may be characterized by the Row and Column number of the business data values chosen. For example, a user may select to simply chart business record 306 of data table 300. Alternatively, the user may chart the entire Row 2 308 of data table 300 or a portion thereof. Thus, data selection enables the user to directly select a range of business data values from a data table that the user desires to chart.

As shown in FIG. 2, the next processing operation is to generate a data chart 204. Using the data selection, the data chart generator 118 generates a data chart for the business data values chosen. In this way, the invention provides for immediate graphical representation of the data selection made by the user. Exemplary chart types that may be generated include vertical bar charts (i.e., column charts), horizontal bar charts (i.e., bar charts), pie charts, line charts, and scatter diagram charts (i.e., dot charts). The generated data chart may depend upon the range of business data values chosen by the user. To illustrate, if the user selects a single business data value (e.g., business record 306) a vertical bar charting the business data value may be generated. If a single row vector (e.g., Row 2 308) is chosen, a vertical bar chart or a line chart may be generated. For a larger number of values, generally over 20, a line chart is preferred because a vertical bar chart becomes increasingly difficult to construe. Conversely, for a smaller number of values, generally 20 or below, a vertical bar chart provides a clear graphical representation that may be interpreted easily.

Similarly, if a single column vector (e.g., Column 3 310) is chosen, a pie chart or a horizontal bar chart may be generated depending on the numbers of values to be charted. For a small number of values, generally 4 or less, a pie chart may be preferred because it offers an efficient means to compare a few values and their relative contribution to the whole. For a larger number of values, generally more than 4, a horizontal bar chart may become preferable. If the user chooses to select an array of values (e.g., multiple rows and columns), a vertical bar chart may be generated with the rows presented side by side. In general, as the number of rows and columns increases, the vertical bar chart becomes more congested and less interpretable.

Returning to FIG. 2, the next processing operation is to record a specified preference 208. The data chart generator 118 may adjust the initial data chart by generating a new data chart to reflect the user's preference. While the data chart generator 118 generates a data chart depending on the range of business data values selected, the user may desire that an alternative data chart be used to graphically represent the business data values. To illustrate, the user may prefer a vertical bar chart to represent a single row vector for a number of values larger than 20. The user may then change the initial line chart that was generated. In the same way, the user may desire that for a larger number of values that a horizontal bar chart is preferred for an array of values. Accordingly, a horizontal bar chart may be generated to replace the default vertical bar chart.

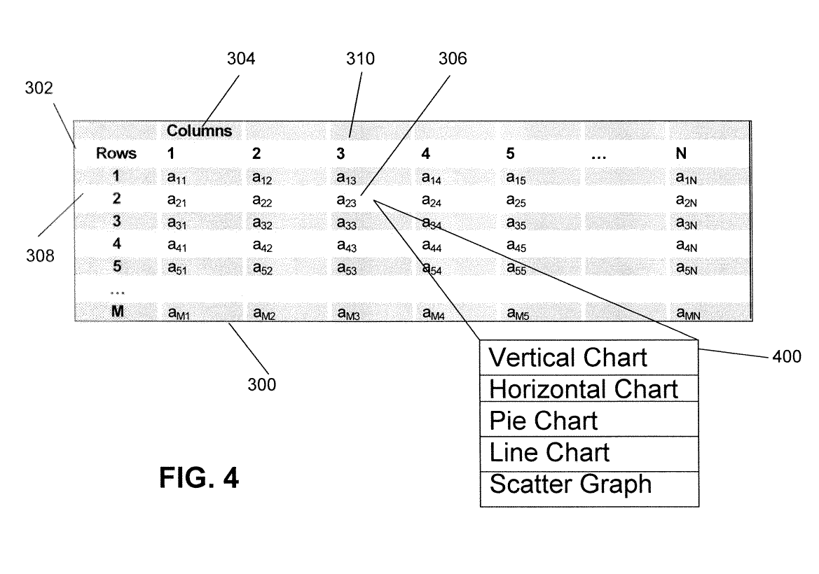

In one embodiment of the invention, a user interface screen may be presented to allow the user to choose a desired graphical representation for the data selection. FIG. 4 illustrates a pull-down menu 400 which may be presented to a user after the user selects data. In this example, the pull-down menu 400 allows a user to specify a vertical bar chart, a horizontal bar chart, a pie chart, a line chart or a scatter plot.

The last processing operation shown in FIG. 2 is to apply the specified preference 210. The data charting module 120 may apply the specified preference to create a revised data chart. The data charting module 120 notes this user preference. This preference is then applied to the data chart generator 118, so that the next time the user selects the same or similar data values in a data table, the user preference is automatically applied to generate a data chart. In this way, the invention adapts to user preferences by associating the user's preferred graphical representation to the specific size of data selection that the user desired to be charted.

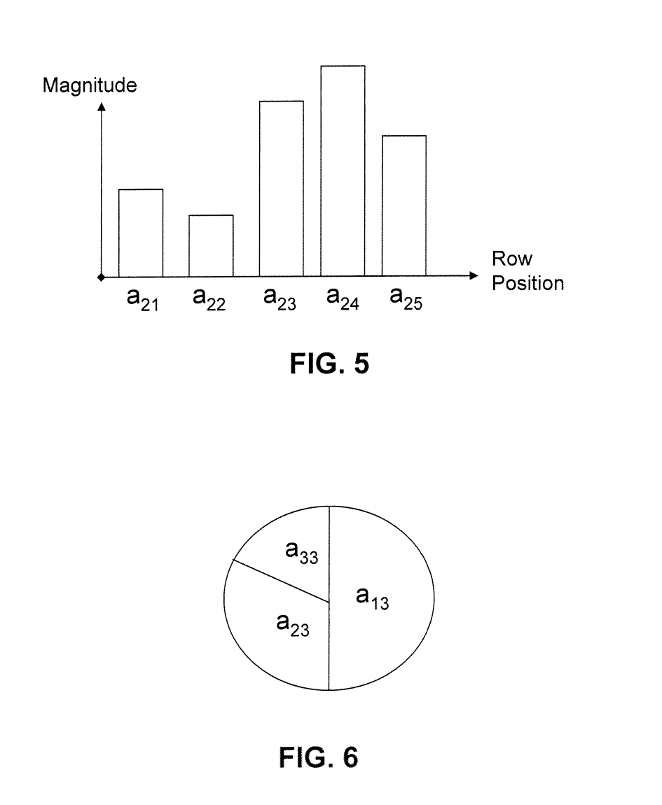

FIG. 5 illustrates a vertical bar chart that is formed in accordance with an embodiment of the invention. In this example, a row of values (a₂₁, a₂₂, a₂₃, a₂₄ and a₂₅) was selected. The magnitude of these values is plotted in a vertical bar chart.

FIG. 6 illustrates a pie chart that is formed in accordance with an embodiment of the invention. In this example, three column values (a₁₃, a₂₃ and a₃₃) were selected. The column values are plotted in a pie chart.

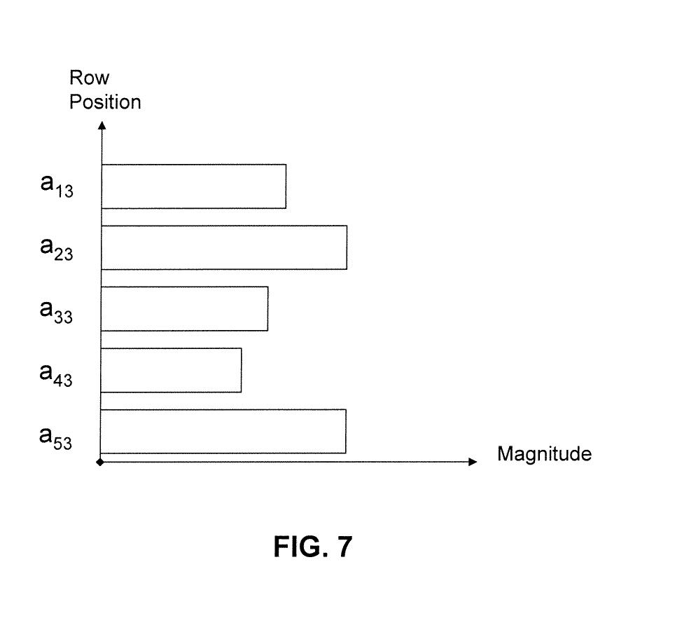

FIG. 7 illustrates a horizontal bar chart that is formed in accordance with an embodiment of the invention. In this example, five column values (a₁₃, a₂₃, a₃₃, a₄₃ and a₅₃) were selected. The column values are plotted in a horizontal bar chart.

The invention enables immediate graphical representation of data selections made by a user and adapts to the user's preferences by associating the range of values desired to be charted to the user's preferred graphical representation. A data chart is immediately generated after the user selects the business data values. The user may change the initially generated chart to another graphical representation. The new user preference is then recorded and applied to future data selections.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

While the present invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt to a particular situation, material, composition of matter, method, process step or steps, to the objective, spirit and scope of the present invention. All such modifications are intended to be within the scope of the claims appended hereto. In particular, while the methods disclosed herein have been described with reference to particular steps performed in a particular order, it will be understood that these steps may be combined, sub-divided, or re-ordered to form an equivalent method without departing from the teachings of the present invention. Accordingly, unless specifically indicated herein, the order and grouping of the steps is not a limitation of the present invention.

What is claimed is:

1. A computer-readable storage medium to direct a computer to function in a specified manner, comprising executable instructions to:
create a data table characterizing data values;
receive a data selection within the data table; and
automatically generate a data chart based on the data selection.

2. The computer-readable storage medium of claim 1, further comprising executable instructions to:
record a specified preference; and
apply the specified preference to create a revised data chart.

3. The computer-readable storage medium of claim 1, wherein the executable instructions to receive a data selection include executable instructions to receive the selection of at least one of a single value, a row, a row vector, a column, a column vector, an array of columns and rows, and an array of column and row vectors.

4. The computer-readable storage medium of claim 1, wherein the executable instructions to automatically generate a data chart include executable instructions to produce at least one of a vertical bar chart, a horizontal bar chart, a pie chart, a line chart, and a scatter plot.

5. The computer-readable storage medium of claim 2, wherein the executable instructions to record a specified preference include executable instructions to present a user interface displaying data chart alternatives

6. A computer implemented method of processing data, comprising:
creating a data table characterizing data values;
receiving a data selection from within the data table; and
automatically generating a data chart based on the data selection.

7. The method of claim 6, further comprising:
recording a specified preference; and
applying the specified preference to create a revised data chart.

8. The method of claim 6, wherein receiving a data selection includes receiving at least one of a single value, a row, a row vector, a column, a column vector, an array of columns and rows, and an array of column and row vectors.

9. The method of claim 6, wherein automatically generating a data chart includes generating at least one of a vertical bar chart, a horizontal bar chart, a pie chart, a line chart, and a scatter plot.

10. The method of claim 7, wherein recording a specified preference includes presenting a user interface displaying data chart alternatives.
